(19) United States
(12) Patent Application Publication
(10) Pub. No.: US 2009/0171711 A1
(43) Pub. Date: Jul. 2, 2009

(54) METHOD AND SYSTEM OF MANAGING TRANSACTIONS

(76) Inventors: Frank Sandoval, Louisville, CO (US); David Hooley, Louisville, CO (US); David Hunter, Longmont, CO (US); Allen Gordon, Nederland, CO (US); Clarke Stevens, Littleton, CO (US)

Correspondence Address: BROOKS KUSHMAN P.C., 1000 TOWN CENTER, TWENTY-SECOND FLOOR, SOUTHFIELD, MI, 48075, US

(21) Appl. No.: 11/967,343

(22) Filed: Dec. 31, 2007

(51) Int. Cl. G06Q 30/00

(52) U.S. Cl. 705/7; 705/26; 705/14

(57) ABSTRACT

Method and system of managing transactions. The transactions may be executed over different networks, such as but not limited to networks associated with different cable television service providers. The transactions may be monitored so that product purchases may be facilitated without requiring product vendors to support electronic communications with each of the networks. The transactions may also be monitored to tabulate metrics and other measurables reported from the different networks in such a manner that the vendors can receive a report without having to understand the reporting and tabulating means used by the different networks to measure the same metrics.

### BACKGROUND OF THE INVENTION

1. Field of the Invention

The present invention relates to methods and systems of selling products over interactive platforms, such as but not limited to interactive platforms operating according to disparate network implementations.

2. Background Art

Different cable television networks, or networks supported by different cable television system providers, commonly referred to as Multiple System Operators (MSO), may support applications/platforms that operate according to different messaging protocols, operating systems, and other proprietary parameters. The disparate operation and proprietary nature of these networks can make it difficult to manage transactions carried out over the different networks.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for managing transaction in accordance with one non-limiting aspect of the present invention;

FIG. 2 illustrates a flowchart of a method for managing product purchase transactions in accordance with one non-limiting aspect of the present invention; and

FIG. 3 illustrates a flowchart of a method for managing metric transactions in accordance with one non-limiting aspect of the present invention.

### DETAILED DESCRIPTION OF THE PREFERRED EMBODIMENT(S)

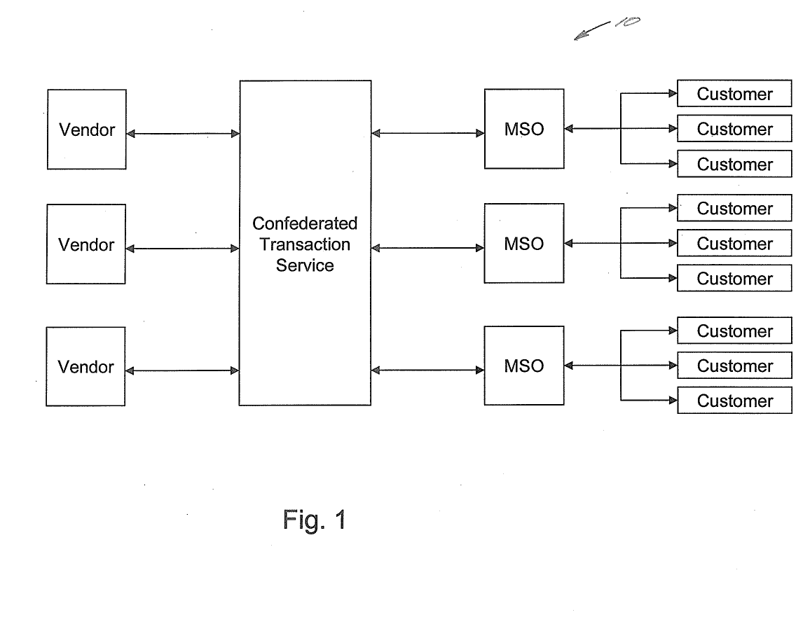

FIG. 1 illustrates a system 10 for managing transactions in accordance with one non-limiting aspect of the present invention. The system may be configured to manage transactions for a number of multiple system operators (MSOs). The MSOs may be cable, satellite, or broadcast television service providers that provide television and/or data related services to a number of customers. The MSOs may also be any other type of service or communications provider that offers services through which customers may purchase goods from a number of vendors and/or consume services. The arrowed lines are intended to refer to any electronic communication medium that allows the illustrated entities to communicate with each other and to support the contemplated services and related transactions.

The present invention contemplates managing any number of transactions executing within the system, which may include but is not limited to electronic transactions between the customers (same or different MSO), the customers and the MSOs, the customers and the vendors, the MSO and the vendors, etc. The transactions contemplated by the present invention are also intended to include single-entity transaction, i.e. transactions other than those carried out between multiple entities, such as but not limited to transactions or operations carried out by one of the entities that does not result in communication or require responsive communications with another one of the entities.

The system 10 may include a confederated transactions services controller to facilitate managing the transactions as contemplated by the present invention. The controller may be configured to provide standardized interfaces that allow the vendors and the MSO to communicate with each other or at least to output commonly understood information. In the cable television industry and other industries, for example, some of the MSO may have disparate messaging systems, protocols, interactive platforms, interfaces or mediums through which the electronic information must travel. Some of the disparate systems may not only transmit information differently but they may also rely on different collection methodologies and metrics to recover and assess information, such as information associated with customer usage/viewing habits.

The MSOs may rely on vendor advertisements and/or the collection of metric information as a source of revenue. In some cases, revenues can be generated from the sale of advertisement opportunities and/or information on customer habits (viewing, operation, etc.). The MSO can maximize revenues by maximizing the number of vendors selling products over their networks or maximizing the resell value of information it can collect on its customer and their habits. The MSOs, however, have had difficulty maximizing vendor reliance since the MSOs require the vendors to develop their own interfaces and support systems to interact with the disparate MSO systems. The present invention contemplates configuring the controller to develop standardized mechanisms through which vendor participation may be facilitated and maximized.

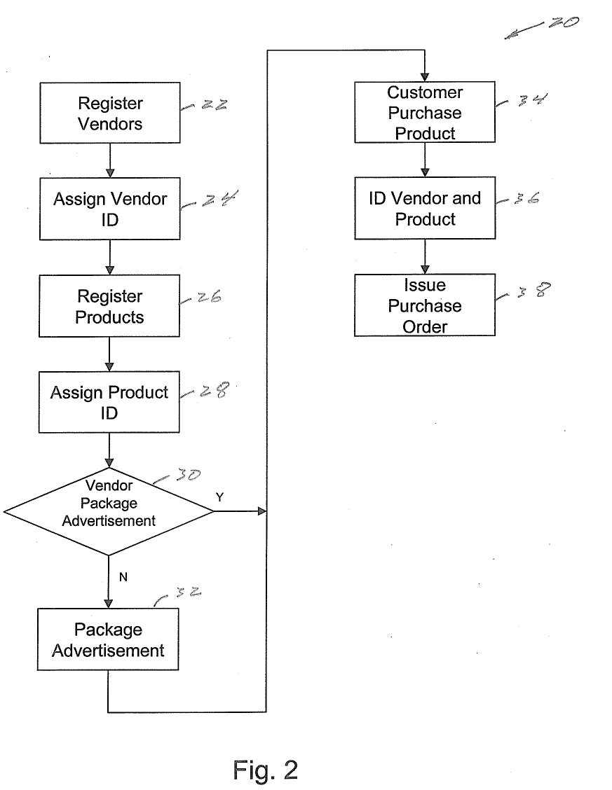

FIG. 2 illustrates a flowchart 20 of method for managing product purchase transactions in accordance with one non-limiting aspect of the present invention. The product purchase transactions may relate to customer purchases of products through an interactive platform or other mechanism provided or supported by the MSOs. These types of transaction generally require delivering an advertisement to the customers, monitoring customer interaction with the advertisement, and supporting purchase order issuance if a customer elects to purchase a product associated with the advertisement. The product purchase transactions may be considered as a multiple entity transaction in so far as the customers may be required to interact with the MSOs and the MSOs may then be required to interact with the vendors in order to facilitate purchase and delivery of the product.

Block 22 relates to registering a product vendor with the confederated transaction service provider. The vendor is intended to refer to an entity desiring to sell products or services (referred to as products) to the customers where at least a portion of the operations associated with facilitating customer purchase of the offered products are executed through communications carried out over one of the MSO's networks. The registration process may include the controller providing a website or other portal where the vendor can input information regarding the vendor, its types of products and services, billing information, and other information that may be necessary to executing the operations contemplated by the present invention.

Block 24 relates to assigning a unique vendor ID to each registered vendor. The vendor IDs may be used to uniquely identify the vendor relative to the other vendors. The controller may use any method to generate unique IDs. The vendor IDs may be determined from information submitted by the vendors during the registration process, with a random number/text generator, and/or some combination thereof. The same vendor may request or be issued multiple vendor IDs as desired, such as to separately identify different product lines or sub-entities. The vendor IDs may be advantageous in allowing vendors having the same name to be separately identified within the system.

Blocks 26, 28 relate to registering the products being offered for sale and assigning unique product IDs to each of the products. During the registration process or at some point thereafter, such as if the vendor is introducing a new product, each vendor may be requested to identify the products it intends to offer for sale. The products may be identified with textual descriptions, pictorial illustrations, or other suitable forms of representation. The controller may then assign a unique product ID to each of the products so that each product is associated with a vendor ID and product ID. If a vendor has multiple products, each product may be may include a different product ID and the same vendor ID.

Blocks 30, 32 relate to determining whether the vendor or the controller is to be responsible for packaging an advertisement used to offer the product for sale. The packaging corresponds with formatting a textual description, picture, or other representation of the product (referred to as an advertisement for the exemplary purposes of the present invention) for use with the interactive services or other service supported by the MSOs. In the case of the vendors packaging the advertisements, the vendors may be responsible for distributing the advertisements to the MSOs. The MSOs may then use the received advertisements for programming or instructing client-side applications to offer the associated product to their customers. This may include any number of operations and processes in order to facilitate customer review of the advertisement, and if desired, its purchase.

The MSOs may support applications running on customer premise equipment (CPE) that allows the customer to interactively purchase products associated with the advertisements. An interactive television (iTV) platform is one such mechanism that a number of MSOs may use to facilitate interactive actions with the customers. The iTV platform can display an advertisement, such as through a television commercial, pop-up/banner ad, or other user accessible interface, and provide a means by which the customer may order the product, such as by clicking on an icon or selecting a button on a remote control. The advertisements provided directly to the MSOs may require formatted according to the particular operating characteristics of the MSOs. If the MSOs rely on standard protocols and messaging requirements, less manipulation may be required for the vendor to package the advertisement for multiple MSOs.

Block 32 relates to the vendors relying on the controller to facilitate the packaging necessary to offering the products for sale over multiple MSO networks. This may include the vendors providing an advertisement in a preferred format to the controller and allowing the controller, or a user associated therewith, to re-format the advertisement according to the messaging, protocols, and other requirements of the MSO systems. The vendors and/or controller may instead rely on a developer to package the advertisements within an application that can be used to facilitate offering the products for sale. The developer may create an application that operates on CPE so that the application can be downloaded or otherwise distributed over the MSO networks to the client-side devices.

Regardless of whether a vendor, developer, or controller provides the advertisements to the MSOs/CPE, the present invention contemplates each advertisement including the vendor ID and product ID associated with the offered product. The format or means by which the IDs run with the advertisements/products may be determined according to the MSO networks and the CPE used to purchase the products.

Block 34 relates to a customer purchasing one of the offered products. The customer may indicate their desire to purchase the product through any number of operations, including the operations described above with respect the iTV platform. A transaction request may be generated in response to the customer purchase request. The transaction request may take many forms depending on the requirements of the associated MSO network and/or operating parameters of the CPE through which the request was made. Each transaction request may at least make reference to the vendor ID and product ID assigned to the purchased product specified in the advertisement. This information may travel with the transaction request for further processing.

Block 36 relates to identifying a vendor and product associated with the vendor and product ID included in the transaction request. The controller may include a database or other feature for cross-referencing the vendor ID and product ID with previously registered vendors and their products. Block 38 relates to issuing a purchase order to the identified vendor for the identified product. The purchase order may be issued to the vendor from the controller or the controller may issue instructions to the MSO of the purchasing customer to communicate the purchase order to the vendor. Billing and shipping information may be included in the transaction request or stored on the controller to facilitate billing and shipping the product to the appropriate customer. In some cases, the customer may be billed directly and/or the MSO may be billed instead of the customer.

As supported above, this method allows the present invention to support the field of distributed software applications and provide a means by which client applications may generate transaction requests, such as those associated with purchasing a product, in a manner that is independent of an access (MSO) network supporting the application. The vendor ID and product ID may be helpful in allowing the client software applications to remain unchanged when executed on any particular access network. A developer of a client application may register with the registration authority (controller), which provides a globally unique value assigned to the developer. The developer can then embed these values into the client application, which attaches it to a transaction request. The format and values in a transaction request can be transmitted to a logical service support by the access network. Because all request may be in a well known format and contain a registered value, all such requests can be associated with the developer, regardless of which client device, on which network, generated the request. The registration authority can resolve the values in the request to the particular developer whose application generated it. Transaction requests may indicate a user request for purchase, for information, for a service, or for any number of actions supported by the developer, an access network, or the set of access networks.

Extending this concept to cable TV, for example, allows the present invention to provide a national marketplace for client applications. A national footprint can provide the scale necessary to attract broadcast programmers and national advertisers, which is important for cable TV revenue generation and competitive position. With no such mechanism, applications would have to be modified to integrate with a particular network's messaging infrastructure, which in turn would have to integrate with any number of developers; or, developers would have to adopt a proprietary messaging scheme which in turn would have to be integrated into each access network's infrastructure. These two alternatives raise significant barriers for developers hoping to reach the entire cable audience. The present invention, in contrast, can be used to provide a single technical interface between developers and a national cable audience, much in the same way that video content is distributed in the same format and through the same mechanisms to all MSOs, so that a single point of contact for application developers can be used to enable message routing and provide the national scale necessary for national content distributors.

The Open Cable Application Platform (OCAP) and Enhanced Television (ETV) capabilities can be leverage in accordance with the present invention to provide a national platform for interactive cable services, much like web browsers create an interactive platform for Internet vendors. Thousands, of large, medium, and small enterprises might author interactive applications that hawk their wares, and deliver these applications to cable subscribers. These programs might be associated with video programming, or might be offered as stand alone services, via virtual or on-demand channels. For example, the present invention contemplates supporting a traditional 30 second ad spot, from which a viewer can place an order, with a model in which unbound applications are made available via an MSOs navigator. An interface may be composed of a standard Graphical User Interface (GUI), which may have a somewhat different visual appearance on different cable systems, in order to fit with the look and feel of the other applications supported by an MSO. Boilerplate code may be part of the interface so that it can execute standard interface functions with viewers and send standardized messages to the MSO transactions services system. Embedded in the code can be certain identifiers and metadata generated by the confederated transaction service used in the messaging to identify the vendor and the product.

From a suppliers' point of view, the economies of scale offered by a single cable t-commerce platform contemplated by the present invention can make the platform much more compelling than having to interface with completely different systems for individual MSOs. This can be helpful in allowing vendors to publish their t-commerce applications to a national cable audience in one step, rather than approaching individual operators. The confederated service, or ‘national cable transaction service’, might be instantiated by a set of web-based forms through which vendors register and configure the billing and fulfillment components. Once registered, a vendor can be issued a unique ID and is given template code to add to their application. Vendors can supply pricing information for individual items. Each item can also be assigned an ID which is incorporated into the application template. Vendor and item IDs can be transmitted from the application during a purchase and used to process an order. After an application is deployed, vendors can interact with the service to receive near-real-time metrics, collect orders, and update the service with order status. Commercial terms might be negotiated with individual MSOs, or mediated by the national cable transaction service.

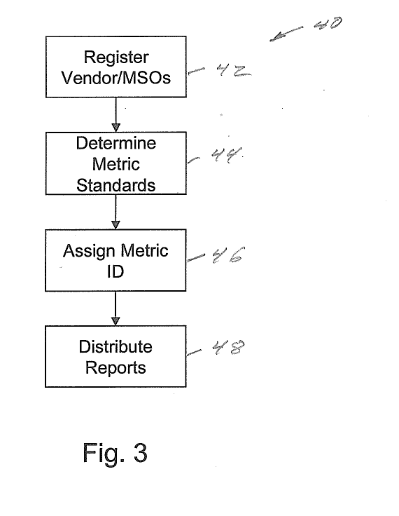

FIG. 3 illustrates a flowchart 40 of a method for managing metric transactions in accordance with one non-limiting aspect of the present invention. The metric transactions may relate to customer interactions with customer premise equipment (CPE), such as but not limited to a settop box (STB), digital vide recorder (DVR), computer, and/or operations carried out on non-customer items, such as but not limited network routers, switches, relays, etc. These types of transactions may be considered as single-entity transactions since they are focused on monitoring interactions, operations or other measurables carried out on a particular device. A management information base (MIB) associated with the devices may be used to monitor the transactions. This type of transaction monitoring can be beneficial to vendors as it allows one to track customer viewing habits and interactions with a website, DVR, or other product/service.

Block 42 relates to registering vendors and MSOs to participate in a standard metric reporting system. The MSOs and vendors may desire a standardized means to report various transactions carried out over their networks. This information can provide vital feedback to the vendor with respect to customer viewing habits (programs, advertisements, behavior while watching, etc.) and may helpful to MSOs in persuading the vendors to increase the number of advertisements. The controller may be configured to register the vendors and MSO in a manner similar to that described above, i.e., with the use of common website or interface. The interface may allow the vendors and/or MSOs to select, vote, or otherwise establish a common set of metrics to be monitored by each of the MSOs.

Block 44 relates to determining a number of standard metrics to be measured by the MSOs. The metrics comprising the standard may be selected based on input from the vendors/MSOs or according to another methodology. Once established, the metrics may be suitable for use with each of the MSOs and their particular operating requirements. Because some of the MSO may measure the same metrics differently, Block 46 may be include to assign a metric ID to each of the metrics. Like the method described above, the metric ID may be used as a message means by which the MSO may attach or embed the metric ID within reporting elements used which the MSO to track the metrics. When the MSO reports the results of the measurements to the controller, the metric ID may be included.

Block 48 relates to the controller generating a report according to the standardized metrics. The report may be tabulated for each of the reporting MSOs and provide a aggregated measurement that the vendors can use to assess performance. The controller may be configured to cross-reference the information provided by the vendors against the metric IDs to tabulate the results from each vendors. Each MSO may report the results in different formats or according to different reporting schemes which the controller can differentiate according the metric IDs. This allows the controller to filter the measured metric and generate a report that can be understood by each of the participating vendors.

The method contemplated by the present invention describes a means by which a service delivery measurement can be collected from a disparate set of service delivery platforms. The system may composed of: a data format supported by any service delivery platform; a transmission protocol that enables any service provider to collect data from delivery platforms; and a data format and infrastructure used to aggregate and report on data collected from various delivery platforms and service providers. This can be useful in normalizing data collection methodology across service platforms, such as to provide: optimal efficiency to service providers and their service partners; and comparability of measurement on varying service platforms.

While the present invention is predominately described above with respect to managing transactions associated with product purchase and metric tabulations. The present invention, however, is not intended to be so limited and fully contemplates it use and application in any other manner. As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of allowing vendors to sell products over multiple cable television networks where each network relies upon disparate interactive platforms to facilitate subscriber purchase of the products, the method comprising:
associating a unique vendor ID with each vendor and a unique product ID with each product;
receiving an advertisement from at least one of the vendors, the advertisement including offers for purchasing one or more products being sold by the at least one of the vendors;
packaging the advertisement for inclusion within at least two of the interactive platforms, the packaging allowing subscribers to navigate and purchase the one or more products, the packaging including the vendor ID and the product ID for each product; and
upon receipt of a purchase confirmation message confirming subscriber purchase of one of the products, the purchase confirmation message including the product ID and vendor ID associated with the purchased product, issuing a purchase order for the product and vendor identified by the product ID and vendor ID included in the confirmation message.

2. The method of claim 1 further comprising determining the vendor ID from vendor information submitted to a vendor transaction service provider.

3. The method of claim 2 wherein the vendor transaction service provider packages the advertisements for inclusion within the at least two of the interactive platforms and transmits the packaged advertisements to cable service providers associated with the at least two of the interactive platforms.

4. The method of claim 1 further comprising processing billing instructions included within the purchase confirmation message and issuing billing instructions to the identified vendor to bill or not bill a purchaser of the product according to the billing instructions.

5. The method of claim 1 further comprising processing shipping instructions included within the purchase confirmation message and issuing shipping instructions to the identified vendor to ship the purchased product to an address specified in the shipping instructions.

6. The method of claim 1 further comprising issuing the purchase order to the vendor in an unencrypted state.

7. A method of selling products over at least two networks having disparate messaging schemes, the method comprising:
assigning unique vendor and product IDs to vendors desiring to sell products, each product being associated with a vendor ID and product ID to facilitate identifying the products and vendors;
after the vendor and product IDs are assigned, including the vendor ID and product ID within transaction requests communicated from client-side devices used to purchase the products; and
upon receipt of the transaction request, identifying the vendor and purchased product from the vendor ID and product ID included within the transaction request.

8. The method of claim 7 further comprising receiving transaction requests for purchasing the same product and according to the disparate messaging schemes of at least two of the networks, wherein each received transaction request includes the same vendor and product ID.

9. The method of claim 8 further comprising formatting the transaction requests such that each transaction request has the same format for the vendor and product IDs.

10. The method of claim 7 further comprising including the vendor ID and product ID within applications executing on the client-side devices.

11. The method of claim 7 further comprising receiving advertisements from the vendors and packaging the advertisement for display on client-side devices operating according to disparate messaging schemes, the client-side devices determining the vendor and product ID from the advertisement.

12. The method of claim 11 further comprising packaging the same advertisements differently for at least two of the networks according to the associated disparate messaging schemes.

13. The method of claim 7 further comprising identifying the vendor of the purchased products with a transaction controller configured to communicate with the each of the networks.

14. The method of claim 7 further comprising issuing a purchase order to the vendor of the purchased product after cross-referencing the vendor ID will billing information previously associated with the vendor ID.

15. A method of managing metrics tabulated from different cable television service providers, the method comprising:
assigning metric IDs to a number of metrics to be measured by the service providers;
instructing the service providers to include the metric ID with the measure metric; and
tabulating the measured metrics from multiple service providers based on the metric IDs included with the measurements.

16. The method of claim 15 further comprising generating a report from the measured metrics and transmitting the report to multiple vendors.

17. The method of claim 16 further comprising registering a number of vendors prior to transmitting the reports and limiting content within each of the transmitted reports to content requested by the vendors during registration.

18. The method of claim 17 further comprising assigning unique vendor and products IDs to products sold by the registered vendors over networks associated with the different cable television service providers and facilitating delivery of purchased products based on the vendor and product IDs being included with a transaction request used to purchase one of the products including the vendor and product IDs.

19. The method of claim 18 further comprising packaging advertisements used to offer products for sale over the different networks, the advertisements including metric, product, and vendor IDs, the metric ID specifying measurement of user interaction with the advertisement and the product and vendor IDs specifying the product and vendor of the purchased product.

20. The method of claim 18 further comprising ordering the purchased product for shipping to a purchasing customer through communications carried out separately from communications between the service providers and customers.
